(19) United States
(12) Patent Application Publication
(10) Pub. No.: US 2010/0307963 A1
(43) Pub. Date: Dec. 9, 2010

(54) Method and System for Filtering Water

(75) Inventor: Michael E. Paice, Las Vegas, NV (US)

Correspondence Address: DUANE MORRIS LLP - San Diego, 101 WEST BROADWAY, SUITE 900, SAN DIEGO, CA, 92101-8285, US

(73) Assignee: THE GOOD WATER COMPANY, INC., Saint Michael, MN (US)

(21) Appl. No.: 12/846,726

(22) Filed: Jul. 29, 2010

Related U.S. Application Data
(62) Division of application No. 11/383,701, filed on May 16, 2006.

(51) Int. Cl. C02F 1/78; C02F 1/44

(52) U.S. Cl. 210/137; 210/192; 210/257.1

(57) ABSTRACT

A water filtration system utilizing line pressure is disclosed. The water filtration system comprises an optional carbon or KDF filter unit or a series of membranes, line pressure filter system, water tank and water pump. Water from a pressurized water source (e.g., municipality water or well) is passed through the carbon or KDF filter and line pressure filter system prior to being deposited into the water tank. A pressure-regulated pump draws water from the water tank upon demand. An automatic pressure regulator on the pump ensures that the water pressure at water-dependent devices (e.g., showers) remains at a desired level regardless of demand. An optional ozone generator may also be incorporated into the system such that water in water tank is provided with O₃. A second water tank may be dedicated to holding and supplying non-purified water thereby eliminating any waste water.

### RELATED APPLICATION

This application is a divisional application of U.S. patent application Ser. No. 11/383,701 filed on May 16, 2006, entitled Water Filtration System, the contents of which are hereby incorporated by reference as if set forth in their entirety.

### TECHNICAL FIELD

The embodiments of the present invention relate to a water purifying system for residential and commercial establishments. More particularly, the embodiments relate to a low pressure water system for purifying water supplied to a residential or commercial establishment.

### BACKGROUND

Water filtration systems are ubiquitous in the United States and throughout the world. Residential and commercial water filtration systems typically treat water supplied by municipalities or from well water. The water is supplied via pressurized piping. Various devices and technologies can be applied to these water supplies to improve the quality of the water. The 4 most prevalent are as follows.

Particulate Filtration: The utilization of a filtration media to remove suspended particles from water—usually removing particles as small as 5 microns in size. The primary drawback to particulate filtration is the relatively short life of the filtration media.

Carbon Filtration: Generally carbon filtration is used for the removal of chlorine or other oxidizing agents. For residential applications carbon filtration is the standard filtration technology used for the removal of chlorine thereby improving water taste and odor. The primary drawbacks to carbon filtration are: a) Relatively short life of the carbon media; and b) By removing the oxidizing agents, the treated water can become more susceptible to bacterial contamination.

Water Softening: This common water treatment technology utilizes ion exchange for the removal of divalent and trivalent ions from water supplies. For light commercial and residential applications, the most common utilization of water softening is the removal of hardness (calcium and/or magnesium) from water supplies by displacing these ions with sodium which is a very soluble ion. The primary drawbacks to water softening are: a) The introduction of sodium (or potassium) chloride into the treated water stream. Such chemicals can cause health risks, especially for individuals on low sodium diets; and b) The potentially high concentration of chloride ions being introduced into the waste stream during system regeneration.

Reverse Osmosis: The technology of reverse osmosis (RO) is generally used in light commercial and residential applications for the removal of the majority of the ions in water supplies. Standard RO systems typically use cross-flow filtration of a feed stream, passed across a semi-permeable membrane, wherein the product water (permeate) contains generally less than 10% of the original ions and the waste stream (concentrate) contains the majority of the ions from the raw water supply. The typical drawbacks of a standard RO system are: a) Waste water is a byproduct of such systems. Generally for residential and light commercial applications 75% of the original raw water becomes waste water and is run to the drain and only 25% of the original feed water becomes potable water; b) In most residential/light commercial applications, pretreatment is required prior to the water reaching the RO membrane. This typically includes particulate filtration, carbon filtration and water softening; c) Since the effectiveness of RO systems is fully dependent on water pressure, most light commercial RO systems required an additional feed water booster pump to increase the inlet pressure to the membrane elements; and d) RO systems typically produce permeate water at very slow rates, so in most residential/light commercial applications a permeate storage tank is required.

Thus, there is a need for a water filtration system that does not require salt or carbon filtration, can be used for light commercial applications without a booster pump; can be used in most applications without pretreatment water softening, operates at higher efficiency and reduces bacteria contamination.

### SUMMARY OF THE INVENTION

According to one aspect, provided is a water purification system comprising a first line filter operable to receive municipal water, a pressurized filter operable to receive first filtered water from the first line filter and produce therefrom purified water and a concentrate without use of a pump, a primary storage tank operable to receive and contain the purified water, and an ozone generator coupled to the primary storage tank and operable to add ozone to the purified water in the primary storage tank. The system further comprises a pump operable to draw the purified water from the primary storage tank and to pump the purified water to multiple purified water reliant devices, a secondary storage tank operable to receive the concentrate from the pressurized filter and contain the concentrate, and a further pump operable to pump the concentrate from the secondary storage tank to a non-purified water reliant device. According to one exemplary embodiment, the first line filter is the only filter between a source of the municipal water and the pressurized filter.

According to another aspect, provided is a water purification system comprising a first line filter operable to receive municipal water, a pressurized filter operable to receive first filtered water from the first line filter and produce therefrom purified water and a concentrate without use of a pump, a primary storage tank operable to receive and contain the purified water, a pump operable to draw the purified water from the primary storage tank and to pump the purified water to multiple purified water reliant devices, a secondary storage tank operable to receive the concentrate directly from the pressurized filter without use of a pump, and contain the concentrate, and a further pump operable to pump the concentrate from the secondary storage tank to a non-purified water reliant device.

According to yet another aspect, provided is a water treatment system comprising a first line filter operable to receive municipal water, a reverse osmosis filter operable to receive first filtered water from the first line filter and produce therefrom purified water and a concentrate without use of a pump, a primary storage tank operable to receive and contain the purified water, and an ozone generator coupled to the primary storage tank and operable to oxidize the purified water in the primary storage tank. The system further comprises multiple purified water reliant devices operable to draw the purified water from the primary storage tank, a secondary storage tank operable to receive the concentrate directly from the pressurized filter without use of a pump and contain the concentrate, and a waste water apparatus operable to draw the concentrate from the secondary storage tank.

Other variations, embodiments and features of the present invention will become evident from the following detailed description, drawings and claims.

### BRIEF DESCRIPTION OF THE DRAWING

FIG. 1 illustrates a first block diagram showing an implementation of a water filtration system of the present invention;

FIG. 2 illustrates a second block diagram of an alternative implementation of a water filtration system of the present invention;

FIG. 3 illustrates a third block diagram of an alternative implementation of a water system of the present invention;

FIG. 4 illustrates a perspective view of a first embodiment of the present invention;

FIG. 5 illustrates a detailed perspective view of a line pressure filter utilized in the current system;

FIG. 6 illustrates a detailed perspective view of a water tank of the present invention;

FIG. 7 illustrates a detailed perspective view of a low power water pump of a first embodiment of the present invention;

FIG. 8 illustrates a detailed view of a pipe configuration of the system;

FIG. 9 illustrates an enclosure for storing and concealing the components of the water filtration system of the present invention; and

FIG. 10 illustrates a system diagram including a waste water tank for directing water to various water-dependent devices which do not require highly purified water.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

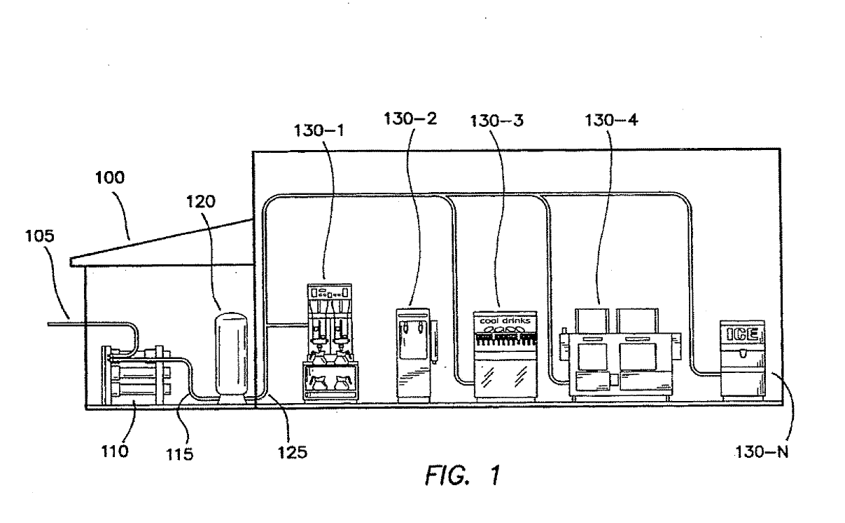

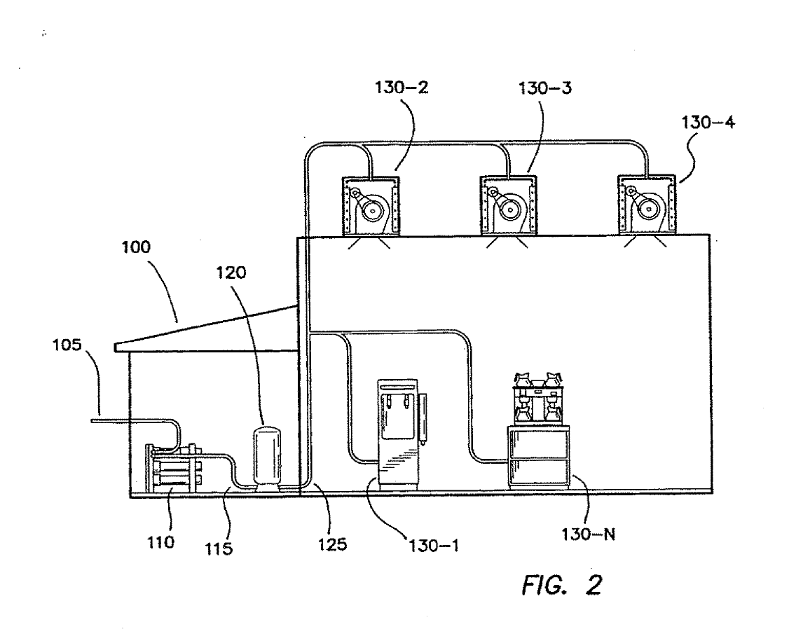

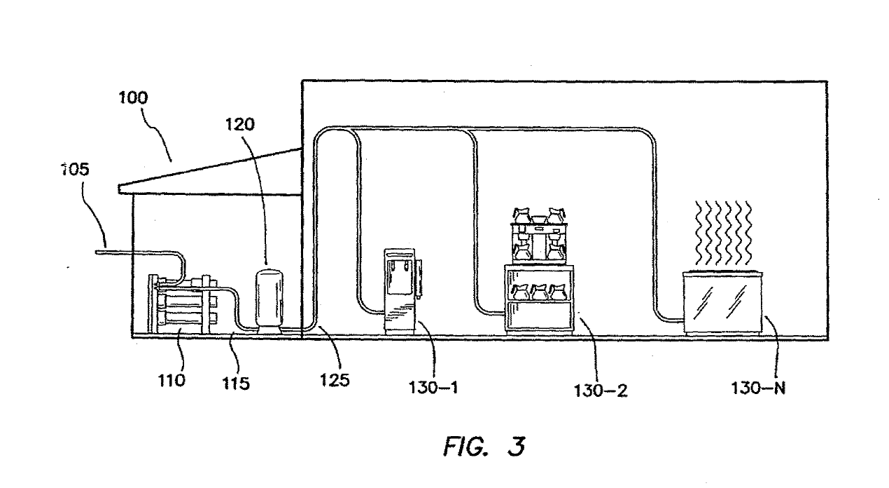

Reference is now made to the figures wherein like parts are referred to by like numerals throughout. FIGS. 1-3 show block diagrams detailing alternative implementations of a water filtration system of the present invention generally referred to by reference numeral 100. As shown, the simplified water filtration system 100 comprises a line pressure filter system 110 and a water tank 120 for storing filtered water. A municipality water (or well) line 105 feeds the line pressure filter system 110 and line 115 directs the purified water to the water tank 120. While water supplied by a municipality or well are discussed herein, any appropriate water source can be connected to the system of the present invention. The water tank 120 is connected to various water-dependent devices 130-1 through 130-N by means of line 125. Upon demand, water from the water tank 120 is directed to the water-dependent device requiring the same: The water-dependent devices 130-1 through 130-N may include commercial devices, like ice machines, or residential devices, like air conditioning units.

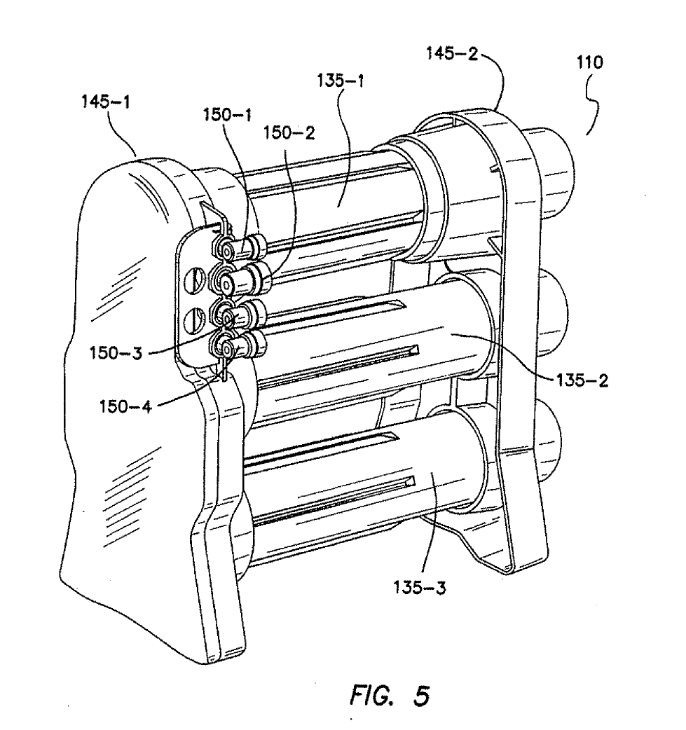

In one embodiment, the line pressure filter system 110 is a reverse osmosis system. One such reverse osmosis system is shown in FIG. 5 and is manufactured by General Electric® and promoted under the name Merlin®. The line pressure filter system 110 operates with line pressure thereby eliminating the need for a pump. In other words, the line pressure supplied by the municipality is sufficient for the line pressure filter system 110. The line pressure filter system 110 utilizes multiple filter technologies including carbon-based and/or reverse osmosis membrane elements to filter the water. The various filters are contained in separate housings 135-1 through 135-3 maintained by a pair of stands 145-1 and 145-2. A fist stand 145-1 includes multiple water inputs and outputs 150-1 through 150-4 designed to receive water lines, pipes and/or tubes.

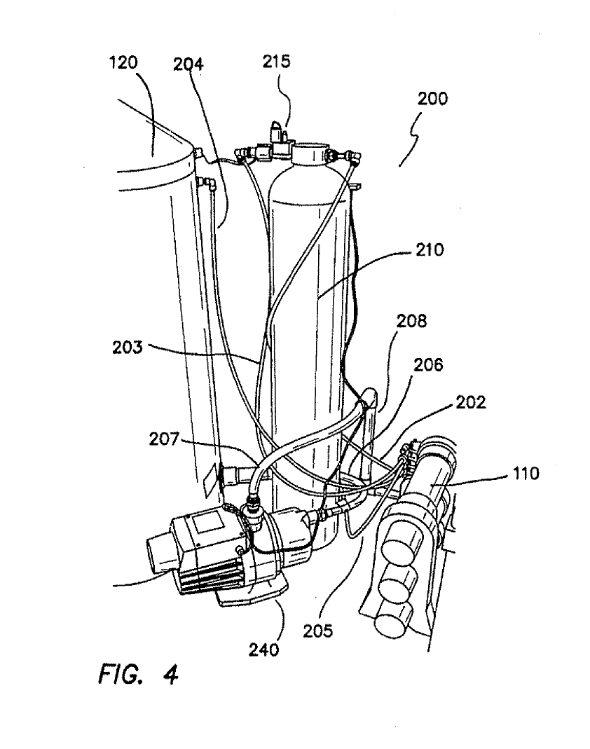

FIG. 4 shows a more comprehensive water filtration system 200 of the present invention. The water filtration system 200 comprises an optional carbon of KDF filter unit 210, line pressure filter system 110, water tank 120 and demand water pump 240. Kinetic Degradation Fluxion (KDF) is a high-purity copper-zinc formulation that uses a basic chemical process known as redox (oxidation/reduction) to remove chlorine, lead, mercury, iron, and hydrogen sulfide from water supplies. Municipality water is first directed via pipe 202 to, and passed through, the optional carbon or KDF filter unit 210.

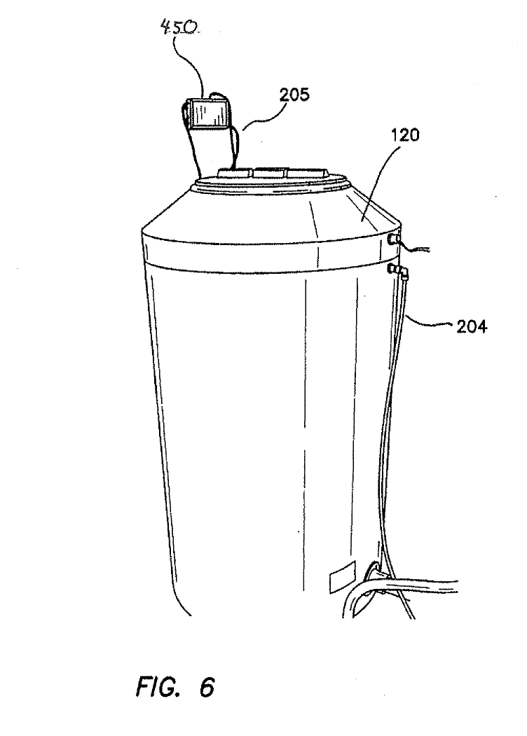

The carbon filter unit 210 shown in FIG. 4 is a conventional canister type carbon filter. However, the carbon or KDF filter can be any suitable type and size. After passing through the carbon or KDF filter unit 210, the water exits the carbon or KDF filter unit 210 and is directed via line 203 to, and passed through, the line pressure filter system 110. Upon exiting the line pressure filter system 110, the water is directed via line 204 to the water tank 120 shown more clearly in FIG. 6. An optional ozone generator 450 is linked to the water tank 120. The ozone generator 240 is operator controlled and, when active, adds O₃ to the water thereby oxidizing the contaminants in the water stored in the water tank 120. The size of the water tank 120 is predicated on the daily water requirements of the establishment using the system embodiments of the present invention.

Upon demand, water is drawn from the water tank 120 via line 206 by the low power demand pump 240. The low power demand pump 240 incorporates a constant output volume regulator that regulates the operation of the pump 240 based on current water demands. Thus, during high water demand periods, the pump 240 provides the necessary pressure to prevent the water pressure at the water-dependent devices to drop. For example, if multiple showers are in use, the pump 240 ensures that the pressure at each showerhead remains at the desired level. During low water demand periods, the demand pump 240 operates at a minimum level. In response to water demand, water is pumped by the demand water pump 240 through line 207 and pipe 208 back into the establishment's water input pipe system which directs the water to the active water-dependent device.

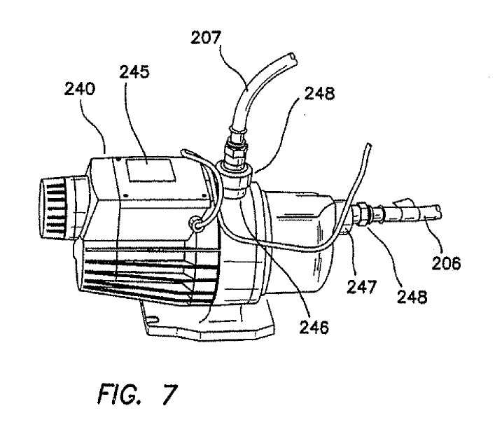

Now referring to FIG. 7, a detailed view of the low power demand pump 240 is shown. The pump 240 incorporates a control panel 245 permitting a user to set the pump 240 to operate within desired parameters. While many pumps may be used, the pump 240 shown in FIGS. 4 and 7 is of the type manufactured by Grundfos or Daveys of Fresno, Calif. The pump 240 includes a threaded input port 246 and threaded output port 247 for receiving a pipe or line. The pipe or line is held in place with a threaded cover member 248.

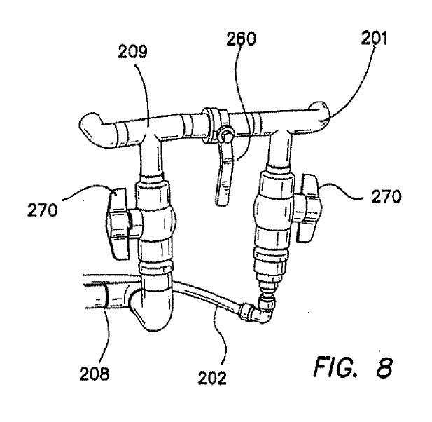

FIG. 8 illustrates a pipe configuration for installing the system of the present invention in a residential home. Municipality water is supplied to the home via pipe 201. Pipe 201 directs water into system line 202 which directs the municipality water to the system 100, namely the carbon filter 210. Upon demand, filtered water, from water tank 120, is directed via pipe 208 to a home input water pipe 209. Valve handle 260 is shown in a closed position and wing knobs 270 are shown in the open position such that the municipality water is directed to the system 100 and back to the home input water pipe 209. To bypass the system 100, valve handle 260 is moved to an open position and wing knobs 270 are turned to closed positions.

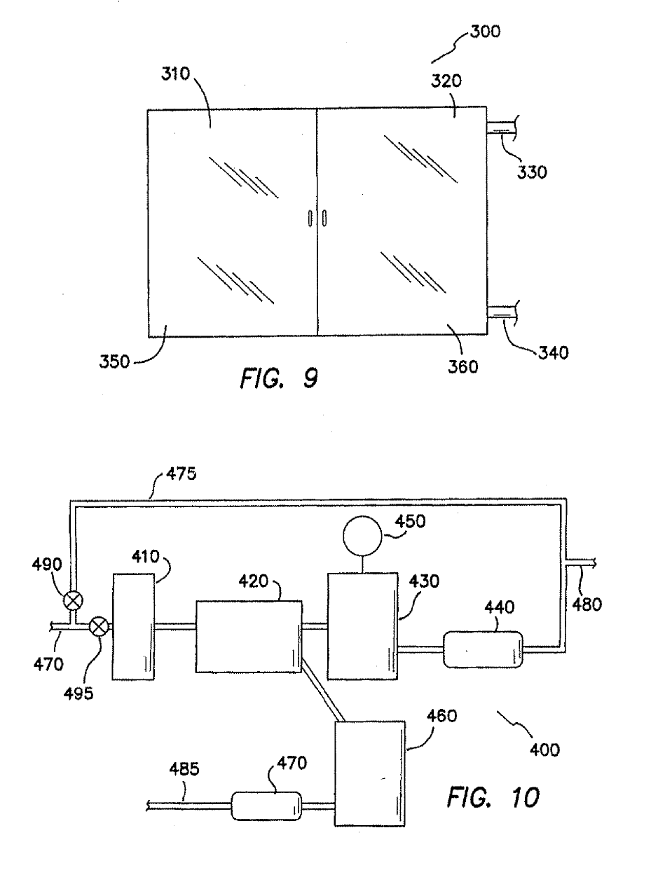

The pipes and lines of the embodiments of the present may be fabricated of any suitable materials, including plastic, stainless steel and PVC, and may be sized to fit any desired application. While the system 100 is shown in an open configuration, FIG. 9 illustrates a housing 300 for concealing the main components of the system 100. The housing has two compartments 310 and 320. Compartment 310 retains as a water tank while compartment 320 houses a carbon filter unit, line pressure filter system and demand pump. As shown, single water line 330 supplying water from the municipality enters the housing 300 and single water line 340 supplying filtered water to the establishment exits the housing 300. The compartments 310 and 320 each are accessible via doors 350, 360.

Now referring to FIG. 10, an alternative system 400, wherein all waste water is utilized, comprises a carbon or KDF filter 410, line pressure filter 420, water tank 430, pump 440 and ozone generator 450 as disclosed above. System 400 further includes a non-purified water tank 460 and secondary pump 470. The non-purified water tank 460 receives drain or rinse water from the line pressure filter 420. The secondary pump 470 supplies the non-purified water to an irrigation system or similar system whereby pure water is not desired or required. Non-purified water means that the water is not as pure as the water supplied to water tank 430. Water enters from a municipality or well via pipe 470. With valve 495 closed and valve 490 open, the water can bypass the system 400 via pipe 475 and enter the house in a normal manner via pipe 480. Opening valve 495 and closing valve 490 directs the water through system 400. Pipe 485 provides a conduit for non-purified water to reach an irrigation system or similar system.

According to one exemplary embodiment, the water filtration system comprises a line pressure filter system operable to receive water from a water source, a water tank adapted to receive water from the line pressure filter system, and a pump operable to draw water from the water tank and force the water to one or more water-dependent devices upon demand.

The system may further include a carbon or KDF filter unit integrated between the water source and the line pressure filter system. The system may further include an ozone generator linked to the water tank. The pump may include a constant output volume regulator. The line pressure filter system may incorporate carbon or KDF-based filter elements and/or reverse osmosis membrane filter elements. The water source may be operated by a municipality or well.

The system may further comprise a second water tank for non-purified water and a second pump operable to draw water from the second water tank and force the water to one or more water-dependent devices. The second water tank may be connected to the line pressure filter system.

According to one exemplary embodiment, a water filtration system is provided that comprises a carbon or KDF filter operable to receive water from a water source, a line pressure filter system adapted to receive water from the carbon or KDF filter, a water tank adapted to receive water from the line pressure filter system, and a pump operable to draw water from the water tank and force the water to one or more water-dependent devices upon demand.

The system may further include an ozone generator for oxidizing water contaminants in the water tank. The pump may include an automatic pressure regulator. The line pressure filter system may utilize carbon or KDF-based filter elements and/or reverse osmosis membrane, filter elements.

The system may include the water source being government controlled or a well. The system may further include a second water tank for non-purified water and a second pump operable to draw water from the second water tank and force the water to one or more water-dependent devices. The second water tank may be connected to the line pressure filter system.

Also provided is a method of filtering water. The method may comprise directing water from a pressurized water source to, and through, a line pressure filter system; directing the water into a water tank; and, upon demand, forcing the water from the water tank to one or more water-dependent devices.

The method may further comprise directing the water to, and through, a carbon or KDF filter unit prior to the water passing through the line pressure filter system, adding O₃ to the water in the water tank prior to forcing the water to the water-dependent devices, and maintaining a constant pressure for the water forced to the one or more water-dependent devices in various embodiments.

The method may further comprise directing water from a municipality operated water source or a well to the line pressure filter, directing non-purified water from the line pressure filter system to a second water tank, forcing the non-purified water from the second water tank to one or more water-dependent devices and forcing the non-purified water to an irrigation system devices in various embodiments.

Although the invention has been described in detail with reference to several embodiments, additional variations and modifications exist within the scope and spirit of the invention as described and defined in the following claims.

What is claimed is:

1. A water purification system comprising:
a first line filter operable to receive municipal water;
a pressurized filter operable to receive first filtered water from the first line filter and produce therefrom purified water and a concentrate without use of a pump;
a primary storage tank operable to receive and contain the purified water;
an ozone generator coupled to the primary storage tank and operable to add ozone to the purified water in the primary storage tank;
a pump operable to draw the purified water from the primary storage tank and to pump the purified water to multiple purified water reliant devices;
a secondary storage tank operable to receive the concentrate from the pressurized filter and contain the concentrate; and
a further pump operable to pump the concentrate from the secondary storage tank to a nonpurified water reliant device,
wherein the first line filter is the only filter between a source of the municipal water, and the pressurized filter.

2. The water purification system of claim 1, wherein the pressurized filter is a reverse osmosis system.

3. The water purification system of claim 1, wherein the first line filter is a carbon filter.

4. The water purification system of claim 1, wherein the first line filter is a KDF (kinetic degradation fluxion) filter and the secondary storage tank is operable to receive the concentrate directly from the pressurized filter without use of a pump.

5. The water purification system of claim 1, wherein the nonpurified water reliant device comprises an irrigation system.

6. The water purification system of claim 1, further comprising a housing having at least two compartments including a first compartment having therein at least one of the primary storage tank and the secondary storage tank and a second compartment having therein at least one of the first line filter and the pressurized filter.

7. The water purification system of claim 1, wherein the pump includes a constant output volume regulator.

8. The water purification system of claim 1, further comprising a control panel and wherein the purified water is drinking water and the pump is controllable by the control panel.

9. The water purification system of claim 1, further comprising a valve operable to divert the municipal water from the first line filter to the multiple purified water reliant devices.

10. A water purification system comprising:
a first line filter operable to receive municipal water;
a pressurized filter operable to receive first filtered water from the first line filter and produce therefrom purified water and a concentrate without use of a pump;
a primary storage tank operable to receive and contain the purified water;
a pump operable to draw the purified water from the primary storage tank and to pump the purified water to multiple purified water reliant devices;
a secondary storage tank operable to receive the concentrate directly from the pressurized filter without use of a pump, and contain the concentrate; and
a further pump operable to pump the concentrate from the secondary storage tank to a nonpurified water reliant device.

11. The water purification system of claim 10, further comprising an ozone generator coupled to the primary storage tank and operable to oxidize the purified water in the primary storage tank.

12. The water purification system of claim 10, wherein the pressurized filter is a reverse osmosis system.

13. The water purification system of claim 10, wherein the first line filter is a carbon filter and is the only filter between a source of the municipal water and the pressurized filter.

14. The water purification system of claim 10, wherein the first line filter is a KDF (kinetic degradation fluxion) filter and the pump includes a constant output volume regulator and a control panel, the pump controllable by the control panel.

15. The water purification system of claim 10, wherein the nonpurified water reliant device is an irrigation system.

16. The water purification system of claim 10, wherein the first filter is the only filter between a source of the municipal water, and the pressurized filter.

17. The water purification system of claim 10, further comprising a valve operable to divert the municipal water from the first line filter to a building equipped with pressurized water piping.

18. A water treatment system comprising:
a first line filter operable to receive municipal water;
a reverse osmosis filter operable to receive first filtered water from the first line filter and produce therefrom purified water and a concentrate without use of a pump;
a primary storage tank operable to receive and contain the purified water;
an ozone generator coupled to the primary storage tank and operable to oxidize the purified water in the primary storage tank;
multiple purified water reliant devices operable to draw the purified water from the primary storage tank;
a secondary storage tank operable to receive the concentrate directly from the pressurized filter without use of a pump, and contain the concentrate; and
a waste water apparatus operable to draw the concentrate from the secondary storage tank.

19. The water treatment system of claim 18, wherein the multiple purified water reliant devices include an air conditioning unit and an ice maker.

20. The water treatment system of claim 18, further comprising:
a valve operable to divert the municipal water from the first line filter to a building;
a housing having at least two compartments including a first compartment having therein at least one of the primary storage tank and the secondary storage tank and a second compartment having therein at least one of the first line filter and the reverse osmosis filter, and
wherein the first line filter is one of a carbon filter and a KDF (kinetic degradation fluxion) filter.
